(19) United States
(12) Patent Application Publication
(10) Pub. No.: US 2015/0311561 A1
(43) Pub. Date: Oct. 29, 2015

(54) DEVICE AND METHOD FOR PROCESSING BATTERY PLATES AND ARRANGING THEM IN WET OR AGM BATTERY CASES FOR CARS OR TRUCKS

(71) Applicant: SASIT INDUSTRIETECHNIK GMBH, Zwickau (DE)

(72) Inventors: Andre FRIEDENBERGER, Fraureuth (DE); Jochen MEIER, Hartenstein (DE)

(21) Appl. No.: 14/651,609

(22) PCT Filed: Dec. 5, 2013
(86) PCT No.: PCT/DE2013/000716

§ 371 Date: Jun. 11, 2015

(30) Foreign Application Priority Data
Dec. 12, 2012 (DE) 10 2012 024 242.5

(51) Int. Cl. H01M 10/04; H01M 10/12

(52) U.S. Cl. CPC H01M 10/0404; H01M 10/128; H01M 2220/20

(57) ABSTRACT

A device for processing battery plates having a centrally arranged processing turntable with a lifting and/or rotating device at the individual processing stations, transporting devices for the battery plates, battery plate packs and finished battery cases. Stationary gripping robots with up to six axes of movement and specially designed grippers are arranged at the processing turntable as a transporting device for feeding the battery plates to be processed and removing the finished battery plates to and from the processing turntable, forming battery plate sets for the battery plate packs, checking the thickness of the set of battery plate packs, straightening and bending the plate lugs, filling the battery cases with the battery plate packs and final inspection. The gripping robots positioned around the processing turntable are arranged movably outside the processing turntable and independently in terms of the sequences of movements.

The invention relates to a device for processing battery plates and arranging them in wet or AGM battery cases for cars or trucks, consisting of a centrally arranged processing turntable with lifting and/or rotating device at the individual processing stations and of transporting devices for the battery plates, battery plate packs and finished battery cases within the device. The invention further relates to a method for processing battery plates and arranging them in battery cases for wet batteries, as well as for AGM batteries for cars and for trucks, which method uses the device according to the invention.

Devices and methods of this type are required for the automated production of automobile batteries.

Plants for processing battery plates and subsequently arranging them in the battery cases are already known from the prior art. Thus DE 102012021784 A1 describes a plant of this type in which this is configured as a compact system comprising four processing stations in total, which are arranged, offset respectively by 90°, around an electrically driven lifting table/turn table, wherein the first processing station serves for the feeding of clamping cassettes loaded with checked battery plates and has for this purpose at least one feeder conveyor belt, a lug aligner which is lowerable from above, a lug bender which is lowerable from above, and a pivot mechanism, the second processing station serves for the tinning of the lugs of the battery plates and has for this purpose at least one feedable fluxing device, a scraper, a drying device and a pivot mechanism,

the third processing station serves as a lead station and has for this purpose at least one casting bridge ejector, at least one heatable lead mold and a depositing/lifting device, and the fourth processing station serves as a boxing station and has for this purpose at least one pivot mechanism,
at least one gripper portal, equipped with at least six grippers, at least two boxing frames, and feeder conveyor belts equipped with a rotating device. A very advantageous solution if sufficient space is present for the erection of the plant. The drawback of this solution consists in the fact that all necessary processing operations are performed at the circular table and, as a result, the necessary cycle time is determined by the station which has the longest dwell time of the clamping cassette with the battery plates to be processed. Generally it is this station at which the clamping cassette must additionally be rotated in order to be able to align the necessary processing stage thereto. These rotating mechanisms are likewise arranged on the circular table. The efficiency of the plant is restricted by the configuration of the cycle times and an absolutely necessary freedom to build for the site of the compact system must be present.

The object of the invention therefore consists in providing a technical solution which overcomes the drawbacks of the prior art. The solution is intended to provide technical options for the efficient and space-saving feeding and removal of battery plates at an automated processing station having a vertically or horizontally disposed processing turntable for processing battery plates and arranging these ready processed battery plate packs in the provided battery cases. The solution is intended moreover to be distinguished by the fact that, as a result of the more effective configuration of necessary work operations, such as, for example, the quality checks, separating operations and necessary boxing operations, savings can be made on the construction engineering costs and the cycle time for the production can be minimized.

According to the invention, the object is achieved by the features of claims 1 and 7, the advantageous embodiments being described in the respective subclaims.

Accordingly, the device for processing battery plates and arranging them in wet or AGM battery cases for cars or trucks firstly consists of a centrally arranged, vertically or horizontally disposed processing turntable with lifting and/or rotating device, arranged at the individual processing stations, for the clamping cassettes loaded with the battery plates to be processed, which clamping cassettes receive as plate packs the battery plates to be processed. The device further consists of separate transporting devices for the supply and removal of the battery plates, plate packs and finished battery cases to and from the processing turntable.

According to the invention, around the processing turntable are arranged separate transporting device for the supply and removal of the yet to be processed and the finished battery plates, plate packs and battery cases, at least two fixed gripping robots equipped with respectively six motional axes. For the formation of battery plate sets for the battery plate packs, for the batch thickness checking of the battery plate packs, for the alignment and bending of the plate lugs, for the boxing of the battery plate packs into the battery cases, and for the final check, the fixed gripping robots are equipped with grippers specifically configured for the respective function. In order to cope in this case with the various battery types, the device according to the invention has for each gripper type of the gripping robots a gripper magazine containing the variously dimensioned gripper heads, which are possibly equipped with auxiliary functions and to which resort can immediately be made for an exchange in the event of a switch in production and also a need for repair. Furthermore, all gripping robots positioned around the processing turntable are arranged so as to be movable, by means of freely programmable linear motion sequences and paths, and outside the processing turntable and independently from the latter in terms of its motion sequences. Hence swift and uncomplicated action can be taken to attain the different cycle times and processing sequences which are necessary in respect of the various battery types, both separately and as preset, respectively assignable programs of movement.

The first gripping robot, which is connected upstream of the processing turntable, has a gripper, which has flange plates that serve to grasp, receive and deposit in a positionally accurate manner both positive and negative battery plates.

The battery plates are here taken from a storage pallet for positive battery plates and from a storage pallet for negative battery plates, in each case separately, by the gripper and fed to the bagging station. The flange plates of the gripper are here designed such that a gentle removal and a gentle and secure transport of the battery plates to the bagging station can be ensured.

A further gripping robot of the device is arranged between the bagging station and a buffer store. The gripper of this gripping robot is equipped with path measuring sensors for the quantitative detection of battery plates during a gripping process for the formation of the batch thickness and for the simultaneous checking of batch thickness for the formation of battery plate packs which have been quality checked in terms of their composition. Hence, when the battery plates are shifted into a buffer store for battery plate packs to be processed, these packs can be formed simultaneously in that the gripper grips the necessary number of positive and negative battery plates. In order to check whether this seizure contains the necessary number of battery plates, the received batch thickness is additionally measured in the gripper. Incorrectly received plate packs are here additionally sorted out by separating them onto a NIO offload conveyor belt.

A further gripping robot stationed between the supply store for the checked plate packs and the processing turntable takes the plate packs checked for batch thickness out of the buffer store and loads the clamping cassettes with the plate packs. Following the loading, the lugs of the battery plates are prepared by the gripper, by means of a special device arranged there for aligning and bending the lugs of the battery plates, for the processing process in which the lugs are aligned and bent.

As a result of this measure, it is possible, on the one hand, to save on a cycle time at the processing turntable and, on the other hand, to dispense with the complex special structures on the turntable for the repeated gripping of the battery plate packs for the lug bending and alignment. Huge savings can also be made on the tool changeover times in the event of a change of battery type in the production, since only the gripper type which is already on hand in the gripper magazine has to be changed.

After this, the gripper delivers the clamping cassette to the first processing station of the processing turntable.

At the processing turntable, the remaining processing sequences take place, such as the fluxing, the tinning, the drying and the formation of lead bridges on the battery plates.

To the last processing station of the processing turntable is assigned the last gripping robot. This takes the ready processed battery plate packs out of the clamping cassette and transports them to the boxing station for the loading of the provided battery cases. The ready processed plate packs are boxed by the gripper of the gripping robot, by means of its rammer system, into the battery cases.

For this purpose, the gripper of this gripping robot has technical means for the purposeful compression and ramming-in of the plate packs. By means of a ramming cylinder and the expander for the individual compartments of the battery cases to be loaded, it boxes the plate packs into the battery cases. For the neat and trouble-free boxing of the ready processed battery plate packs, the gripper further has a stretching device for expanding the individual battery case compartments prior to boxing of the ready processed plate packs. Hence the boxing of the plate packs into the individual, very narrowly dimensioned compartments of the battery cases can be realized with a high quality, since damage to the ready processed plate packs, which are therefore very susceptible to mechanical stress, can be precluded.

In order to check the quality of the finished battery cases, the gripper further has a weighing measuring system in order to register the weight of the ready-loaded battery cases and balance it with the desired measure. If an error message ensues, this battery case is separated out.

The other finished battery cases which exhibit the necessary quality are transported by the gripper onto a lead-off conveyor belt.

In the production of AGM battery types, this gripper of the last gripping robot additionally has, for the secure boxing of the AGM battery plate packs, a force measuring device in the form of force measuring sensors, in order to transfer to the plate packs in a controlled manner the press-in force which must be expended to box the plate packs into the battery cases. This is necessary in order to avoid damaging the AGM battery plates or the glass fiber mats bonded to the electrolyte.

With this technical measure, it is in turn possible to save on several mechanical engineering measures with respect to the turntable and axis systems for the boxing and transportation of the battery plate packs and of the finished battery cases.

At the same time, following the boxing, already during transport of the finished battery cases out of the device, quality control and separation of the good quality from a substandard quality of the battery cases are performed. Valuable cycle time is saved and it is ensured that only battery cases with a predefined quality leave the device for processing battery plates and arranging them in wet or AGM battery cases for cars or trucks.

The separate configuration of the transport of battery plates, plate packs and battery cases outside the processing turntable has the advantage that a swift and uncomplicated reaction can be made to the retooling when the production is switched to another battery type. A space-saving and individual reaction can be made to existing spatial relationships in connection with the incorporation of a new plant. The gripping robot technology can be separately configured only in the area of gripper technology and can be preconceived for the mass production of such devices.

The invention shall be explained in greater detail below on the basis of an illustrative embodiment.

In the appended drawing:

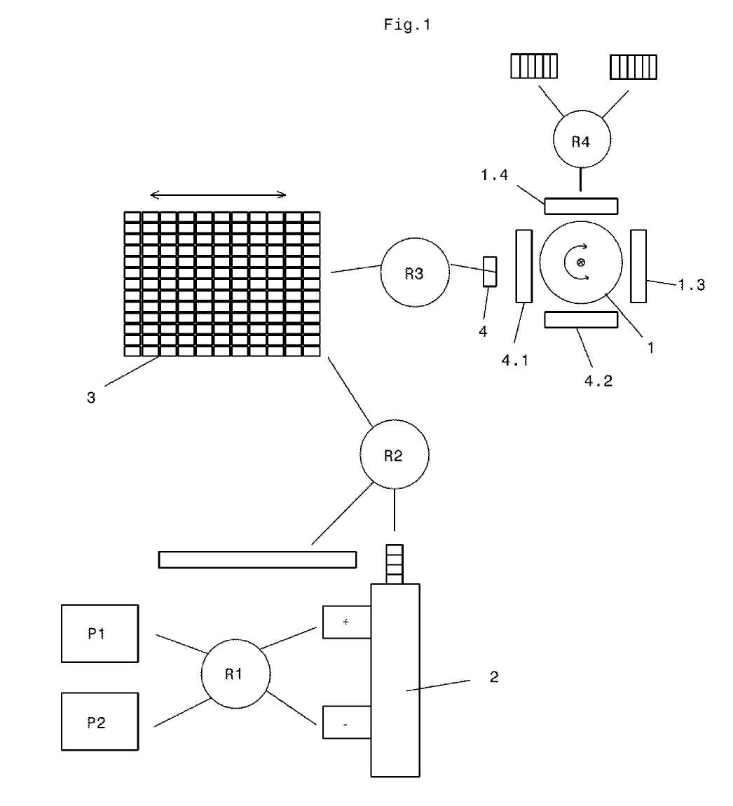

FIG. 1 shows a schematic top view of the arrangement of the gripping robots relative to the central processing turntable within the device for processing battery plates and arranging them in wet or AGM battery cases, and

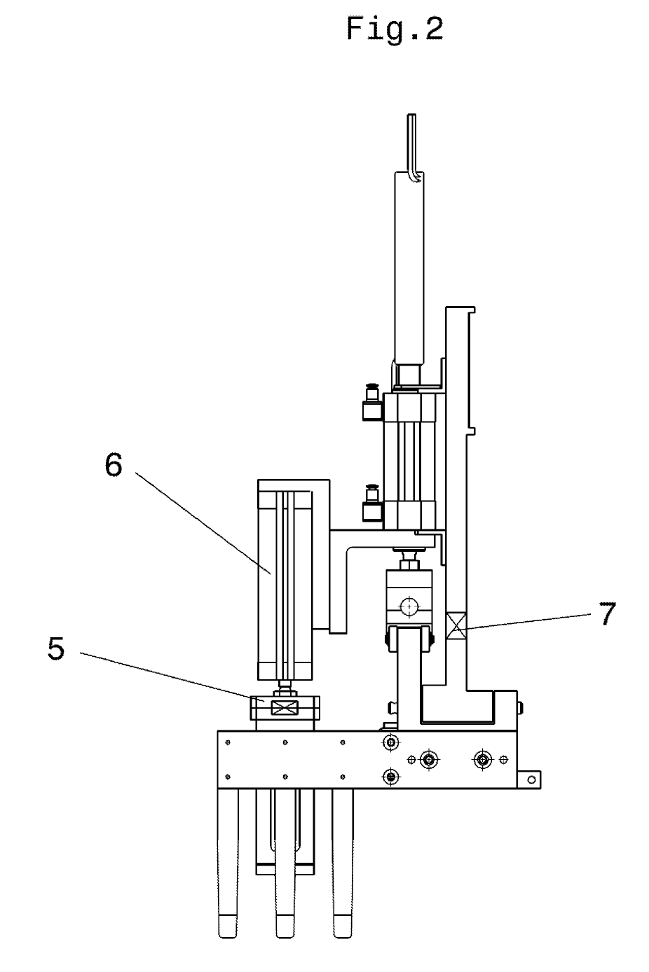

FIG. 2 shows the schematic side view of a gripper of a gripping robot having a ramming cylinder for boxing the finished battery plate packs into the provided battery cases, a force measuring device for measuring the push-in force during the boxing, and a device for checking the weight of the finished battery cases.

### ILLUSTRATIVE EMBODIMENT

According to FIGS. 1 and 2, a device for processing battery plates and arranging them in wet or AGM battery cases for cars or trucks firstly consists of a centrally arranged processing turntable 1 with lifting and/or rotating device at the individual processing stations 1.1-1.4, and of transporting devices R1-R4 for the battery plates, battery plate packs and finished battery cases within the device.

At the turntable are arranged, according to the invention, fixed gripping robots R1-R4, equipped with six motional axes and with specially configured grippers, as the transporting device for the supply and removal of the battery plates to be processed and of the finished battery plates toward and away from the processing turntable 1 for the formation of battery plate sets for the battery plate packs, for the batch thickness checking of the battery plate packs, for the alignment and bending of the plate lugs, for the boxing of the battery plate packs into the battery cases, and for the final check. A combination of transporting and processing tool is thereby realized in the gripping robots R1-R4 and processing steps are shifted from the processing turntable 1 into the transporting devices. Thus not only can space be saved and flexibly configured, but also valuable cycle time can be saved.

All gripping robots R1-R4 positioned around the processing turntable 1 are arranged by means of freely programmable linear motion sequences and paths movably outside the turntable and independently from the latter in terms of its motion sequences. With this measure, action can be taken in terms of production engineering and design to attain the specific on-site conditions in the erection of a processing plant, flexibly and without great construction complexity.

In order to realize the transportation of the supply pallets P1 and P2 to the bagging station 2, which supply pallets are assigned to the device for the stockpiling of respectively positive and negative battery plates, at a first gripping robot R1, and there at its gripper, are arranged flange plates, which serve to grasp and receive both the positive and negative battery plates from the supply pallets P1 and P2 and to deposit the battery plates in a positionally accurate manner in the bagging station 2. These flange plates are intended to prevent the battery plates from being damaged in the course of the grasping, reception, transportation and depositing.

The battery plates in the bagging station, which are now fixed in their order, are received by a second gripping robot R2 such that, via the path measuring system arranged on the gripper of the gripping robot R2, the plate pack size predefined for the battery type to be produced is taken by the gripper, whereupon the grabbed batch thickness is additionally checked by means of the path measuring sensors, and the flawless plate packs are delivered to a buffer store 3. The plate packs determined with an error measurement are separated onto an offload conveyor belt.

It is thus ensured that only those battery plate packs which contain the predefined number of plates are further processed. The buffer store 3 ensures that no cycle arrest ensues at the processing turntable 1 owing to an absence of battery plate packs, so that the device can be utilized and operate effectively. A gripping robot R3 takes the checked plate packs out of the buffer store 3 and loads the clamping cassettes 4 therewith. The gripper is equipped with special tools. With these tools, the lugs of the battery plates are aligned and bent by the gripper and the gripper delivers the loaded clamping cassette to the processing station 1.1 of the processing turntable 1. At the processing turntable, the usual processing steps, such as the fluxing, the tinning, the drying and the casting of lead bridges on the battery plates are realized in the processing stations 1.1-1.4. A further gripping robot R4 is assigned at the last processing station 1.4 and also outside the processing turntable 1. The gripper takes the ready processed battery plate packs out of the clamping cassette and boxes them into the provided battery cases. For this purpose, the gripper is additionally equipped with a rammer system in the form of a boxing ram. The gripper next grasps the ready loaded battery case and determines during transport from the processing station 1.4 the weight of the battery case and compares the value with the predefined desired value in order to separate out the battery case having an incorrect weight. The battery cases having the predefined weight quality are delivered to the finished parts store.

If the AGM battery type is produced, then the gripper of the gripping robot R4 additionally has a force measuring sensor 5. This measures and initiates the regulation of the push-in force during boxing of the AGM battery plate packs into the battery cases. The push-in force is thereby transferred to the plate packs in a controlled manner. This is necessary in order to avoid damaging the AGM battery plates or the glass fiber mats bonded to the electrolyte.

A device of this type has the advantages that it, on the one hand, can be fitted without additional design effort into the structure which is respectively already in place on site.

Through the assumption of processing functions by the gripping robots R1 to R4, the cycle times at the processing turntable 1 are shortened and the complicated construction complexity at the processing turntable 1 for the realization of these functions can be dispensed with, which leads to reduction in costs. The otherwise necessary construction of axis systems for the transport of the battery plates, the plate packs and the battery cases can also be dispensed with. In addition, the quality controlling measurements are performed by the gripping robots R1-R4, which leads to an improved guarantee of quality.

Device and Method for Processing Battery Plates and Arranging them in Wet or AGM Battery Cases for Cars or Trucks

### REFERENCE SYMBOL LIST

1 processing turntable
1.1-1.4 processing stations at the processing turntable
2 bagging station
3 buffer store
4 clamping cassette
5 force measuring sensors
6 ramming cylinder
7 weighing measuring system
R1-R4 gripping robots
P1-P2 supply pallets

1. A device for processing battery plates and arranging them in wet or AGM battery cases, comprising:
a centrally arranged processing turntable with at least one of a lifting and rotating device at the individual processing stations, and
transporting devices for the battery plates, battery plate packs and finished battery cases within the device,
wherein fixed gripping robots are arranged at the processing turntable equipped with up to six motional axes and with specially configured grippers, as the transporting device for the supply and removal of the battery plates to be processed and of the finished battery plates toward and away from the processing turntable for the formation of battery plate sets for the battery plate packs, for the batch thickness checking of the battery plate packs, for the alignment and bending of the plate lugs, for the boxing of the battery plate packs into the battery cases, and for the final check, in that all gripping robots positioned around the processing turntable are arranged so as to be movable, by way of freely programmable linear motion sequences and paths, outside the processing turntable and independently from the latter in terms of its motion sequences.

2. The device for processing battery plates and arranging them in wet or AGM battery cases as claimed in claim 1, wherein on the gripper of the gripping robot are arranged flange plates which serve to grasp and receive from the supply pallets for positive battery plates and for negative battery plates, and deposit in a positionally accurate manner, both positive and negative battery plates.

3. The device for processing battery plates and arranging them in wet or AGM battery cases as claimed in claim 1, wherein the gripper of the gripping robot is equipped with path measuring sensors for the quantitative detection of battery plates during a gripping process for the formation of the batch thickness and for the simultaneous checking of batch thickness for the formation of quality checked battery plate packs.

4. The device for processing battery plates and arranging them in wet or AGM battery cases as claimed in claim 1, wherein on the gripper of the gripping robot is arranged a device for aligning and bending the lugs of the battery plates.

5. The device for processing battery plates and arranging them in wet or AGM battery cases as claimed in claim 1, wherein the gripper of the gripping robot has technical means for the purposeful compression and ramming-in of the plate packs by means of a ramming cylinder and the expansion of the individual compartments into the battery cases to be loaded, and has a weighing measuring system for registering the weight for quality control purposes prior to loading of the ready processed plate packs into the provided battery cases.

6. The device for processing battery plates and arranging them in wet or AGM battery cases as claimed in claim 1, wherein to each gripping robot of the device is assigned a magazine for various gripping robot heads adapted to the respective battery type.

7. A method for processing battery plates and arranging them in wet or AGM battery cases as claimed in
claim 1, wherein the gripping robot takes the positive and negative battery plates from the various supply pallets and delivers them to the bagging station for the stockpiling of battery plate sets for plate packs which are to be formed;
in that the gripping robot takes the plate packs from the supply conveyor belt of the bagging station, while checking the batch thickness of the plate packs with the path measuring sensors arranged on the gripper head,
in that the gripping robot separates the incorrectly formed plate packs from the qualitatively correctly formed plate packs and delivers the qualitatively correctly formed plate packs to a buffer store;
in that the gripping robot takes plate packs which have been checked for batch thickness from the buffer store, loads the clamping cassettes with the plate packs, and then aligns and bends the lugs of the battery plates and delivers these to the first processing station of the processing turntable;
in that at the processing turntable the remaining processing sequences, such as the fluxing, the tinning, the drying and the formation of lead bridges on the battery plates, take place, and
in that the gripper of the gripping robot at the last processing station of the processing turntable removes the ready processed battery plate packs from the clamping cassette and, at the boxing station for the loading of the provided battery cases, receives the plate packs, boxed into the battery cases by means of a rammer system, in the form of a ramming cylinder, arranged on the gripper, as well as the ready loaded battery cases, checks the end weight of the battery case by means of a weighing system, and compares it with the desired value in order to separate the substandard from the quality battery cases.

8. The method for processing battery plates and arranging them in wet or AGM battery cases as claimed in claim 7, wherein, in the boxing of the ready processed AGM battery plate packs by means of the force measuring sensors additionally arranged on the gripper of the gripping robot, the push-in force is measured and regulated for controlling and dimensioning purposes.

9. The device for processing battery plates and arranging them in wet or AGM battery cases as claimed in claim 2, wherein the gripper of the gripping robot is equipped with path measuring sensors for the quantitative detection of battery plates during a gripping process for the formation of the batch thickness and for the simultaneous checking of batch thickness for the formation of quality checked battery plate packs.

10. The device for processing battery plates and arranging them in wet or AGM battery cases as claimed in claim 2, wherein on the gripper of the gripping robot is arranged a device for aligning and bending the lugs of the battery plates.

11. The device for processing battery plates and arranging them in wet or AGM battery cases as claimed in claim 3, wherein on the gripper of the gripping robot is arranged a device for aligning and bending the lugs of the battery plates.

12. The device for processing battery plates and arranging them in wet or AGM battery cases as claimed in claim 2, wherein the gripper of the gripping robot has technical means for the purposeful compression and ramming-in of the plate packs by means of a ramming cylinder and the expansion of the individual compartments into the battery cases to be loaded, and has a weighing measuring system for registering the weight for quality control purposes prior to loading of the ready processed plate packs into the provided battery cases.

13. The device for processing battery plates and arranging them in wet or AGM battery cases as claimed in claim 3, wherein the gripper of the gripping robot has technical means for the purposeful compression and ramming-in of the plate packs by means of a ramming cylinder and the expansion of the individual compartments into the battery cases to be loaded, and has a weighing measuring system for registering the weight for quality control purposes prior to loading of the ready processed plate packs into the provided battery cases.

14. The device for processing battery plates and arranging them in wet or AGM battery cases as claimed in claim 4, wherein the gripper of the gripping robot has technical means for the purposeful compression and ramming-in of the plate packs by means of a ramming cylinder and the expansion of the individual compartments into the battery cases to be loaded, and has a weighing measuring system for registering the weight for quality control purposes prior to loading of the ready processed plate packs into the provided battery cases.

15. The device for processing battery plates and arranging them in wet or AGM battery cases as claimed in claim 2, wherein to each gripping robot of the device is assigned a magazine for various gripping robot heads adapted to the respective battery type.

16. The device for processing battery plates and arranging them in wet or AGM battery cases as claimed in claim 3, wherein to each gripping robot of the device is assigned a magazine for various gripping robot heads adapted to the respective battery type.

17. The device for processing battery plates and arranging them in wet or AGM battery cases as claimed in claim 4, wherein to each gripping robot of the device is assigned a magazine for various gripping robot heads adapted to the respective battery type.

18. The device for processing battery plates and arranging them in wet or AGM battery cases as claimed in claim 5, wherein to each gripping robot of the device is assigned a magazine for various gripping robot heads adapted to the respective battery type.

19. The method for processing battery plates and arranging them in wet or AGM battery cases as claimed in claim 2, wherein the gripping robot takes the positive and negative battery plates from the various supply pallets and delivers them to the bagging station for the stockpiling of battery plate sets for plate packs which are to be formed;
in that the gripping robot takes the plate packs from the supply conveyor belt of the bagging station, while checking the batch thickness of the plate packs with the path measuring sensors arranged on the gripper head,
in that the gripping robot separates the incorrectly formed plate packs from the qualitatively correctly formed plate packs and delivers the qualitatively correctly formed plate packs to a buffer store;
in that the gripping robot takes plate packs which have been checked for batch thickness from the buffer store, loads the clamping cassettes with the plate packs, and then aligns and bends the lugs of the battery plates and delivers these to the first processing station of the processing turntable;
in that at the processing turntable the remaining processing sequences, such as the fluxing, the tinning, the drying and the formation of lead bridges on the battery plates, take place, and
in that the gripper of the gripping robot at the last processing station of the processing turntable removes the ready processed battery plate packs from the clamping cassette and, at the boxing station for the loading of the provided battery cases, receives the plate packs, boxed into the battery cases by means of a rammer system, in the form of a ramming cylinder, arranged on the gripper, as well as the ready loaded battery cases, checks the end weight of the battery case by means of a weighing system, and compares it with the desired value in order to separate the substandard from the quality battery cases.

20. The method for processing battery plates and arranging them in wet or AGM battery cases as claimed in claim 3, wherein the gripping robot takes the positive and negative battery plates from the various supply pallets and delivers them to the bagging station for the stockpiling of battery plate sets for plate packs which are to be formed;
in that the gripping robot takes the plate packs from the supply conveyor belt of the bagging station, while checking the batch thickness of the plate packs with the path measuring sensors arranged on the gripper head,
in that the gripping robot separates the incorrectly formed plate packs from the qualitatively correctly formed plate packs and delivers the qualitatively correctly formed plate packs to a buffer store;
in that the gripping robot takes plate packs which have been checked for batch thickness from the buffer store, loads the clamping cassettes with the plate packs, and then aligns and bends the lugs of the battery plates and delivers these to the first processing station of the processing turntable;
in that at the processing turntable the remaining processing sequences, such as the fluxing, the tinning, the drying and the formation of lead bridges on the battery plates, take place, and
in that the gripper of the gripping robot at the last processing station of the processing turntable removes the ready processed battery plate packs from the clamping cassette and, at the boxing station for the loading of the provided battery cases, receives the plate packs, boxed into the battery cases by means of a rammer system, in the form of a ramming cylinder, arranged on the gripper, as well as the ready loaded battery cases, checks the end weight of the battery case by means of a weighing system, and compares it with the desired value in order to separate the substandard from the quality battery cases.
